(19) United States
(12) Patent Application Publication
(10) Pub. No.: US 2010/0326336 A1
(43) Pub. Date: Dec. 30, 2010

(54) MULTI-LAYER PANEL

(75) Inventors: CLAYTON W. STRUTHERS, HIRAM, OH (US); DENNIS D. LOYD, LIBERTY TOWNSHIP, OH (US); JOHN P. CREAMER, SR., GARRETTSVILLE, OH (US)

Correspondence Address: CALFEE HALTER & GRISWOLD, LLP, 800 SUPERIOR AVENUE, SUITE 1400, CLEVELAND, OH, 44114, US

(73) Assignee: MANTICORE INTERNATIONAL, LLC, HIRAM, OH (US)

(21) Appl. No.: 12/825,094

(22) Filed: Jun. 28, 2010

Related U.S. Application Data
(60) Provisional application No. 61/220,764, filed on Jun. 26, 2009.

(51) Int. Cl. E04H 9/04; B32B 13/12

(52) U.S. Cl. 109/78; 428/703; 428/339

(57) ABSTRACT

A multi-threat panel includes two first layers of polyurea mix, for at least one of reflecting and attenuating blast pressure and restricting ballistic penetration of the panel, and a layer of a concrete mix, including a ceramic aggregate, for increasing resistance to blast pressure and ballistic penetration of the panel. The first layers coat the concrete layer.

This application claims the benefit of U.S. Provisional Application No. 61/220,764, filed Jun. 26, 2009, which is hereby incorporated by reference.

### BACKGROUND

The present invention relates to blast, ballistics, and radiation protection. It finds particular application in conjunction with a multi-layer panel that provides the blast, ballistics, and radiation protection and will be described with particular reference thereto. It will be appreciated, however, that the invention is also amenable to other applications.

Due to current events worldwide, manmade disasters are at an all time high. From ballistic and blast attacks (such as IED's, RPG's, etc.), to dirty bombs, and nuclear weapons (radiation), it is evident that there is a need for protective materials that cover a multitude of varying threat assessments. Many products have been invented with a common goal of protecting human life and infrastructure.

Products such as concrete, fiberglass, steel, and polyurethane coatings have been used in various applications to protect human life and infrastructure. However, recent examples of products utilizing such materials have only been adequate for a single intended purpose (e.g., concrete to reduce blast pressure, polyurea used for its binding property to reduce blast damage; and ballistic fiber glass to reduce damage from small arms fire). For example, Russell Fisher (U.S. Pat. No. 6,177,368 B1), in 2001, used PVC and Fiberglass to protect against blast pressures. Bartuski (U.S. Pat. No. 4,953,442) used ceramics and fiberglass to protect against ballistics. Lead and concrete have been used as the primary source for protection against multi-spectral-radiations, resulting in ecological debates regarding the creation and disposal of lead based products.

No single product offering protection against blasts, ballistics, and radiations is currently available that may be manufactured in multiple shapes and sizes to accommodate retrofitting on existing structures (e.g., embassies, Federal installations, perimeter structures, and/or refineries).

The present invention provides a new and improved apparatus which addresses the above-referenced problems.

### SUMMARY

In one aspect of the present invention, it is contemplated that a multi-threat panel includes two first layers of polyurea mix, for at least one of reflecting and attenuating blast pressure and restricting ballistic penetration of the panel, and a concrete layer of concrete mix, including a ceramic aggregate, for increasing resistance to blast pressure and ballistic penetration of the panel. The first layers coat the concrete layer.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a exterior schematic representation of a multi-layer panel in accordance with one embodiment of an apparatus illustrating principles of the present invention;

FIG. 2 illustrates a schematic representation of a cross-sectional view of the panel along the line 2-2 shown in FIG. 1 in accordance with one embodiment of an apparatus illustrating principles of the present invention; and

FIG. 3 illustrates a bullet broken into pieces after being fired into a multi-layer panel in accordance with one embodiment of an apparatus illustrating principles of the present invention.

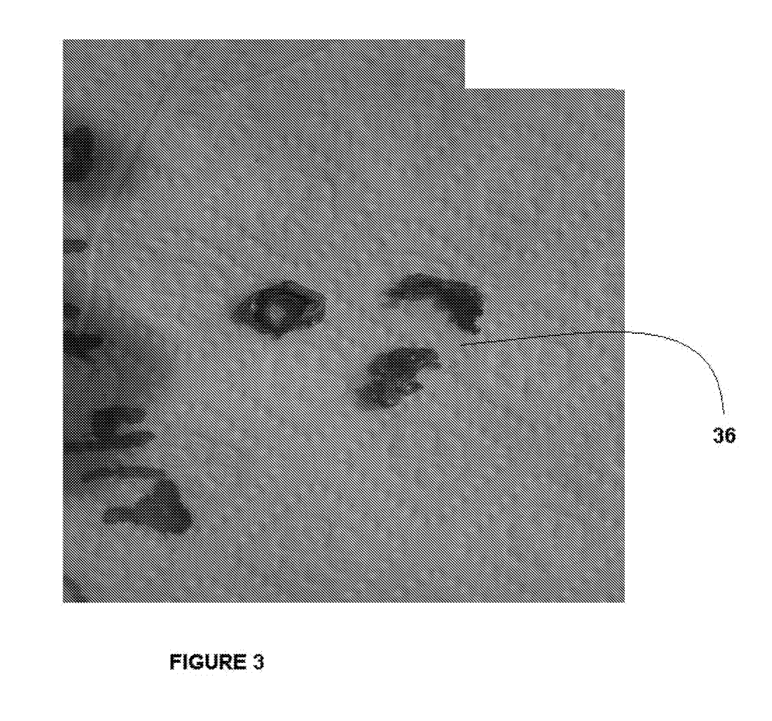

### DETAILED DESCRIPTION OF ILLUSTRATED EMBODIMENT

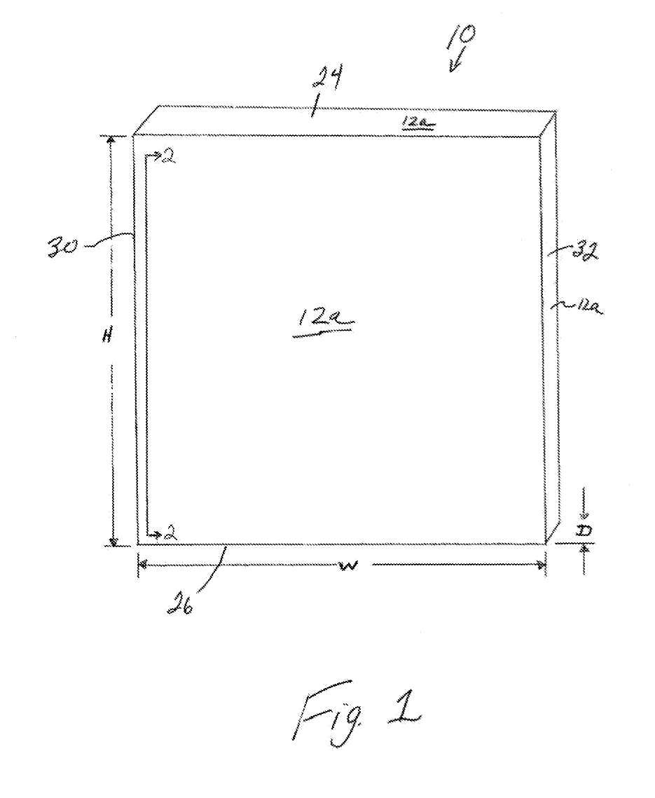

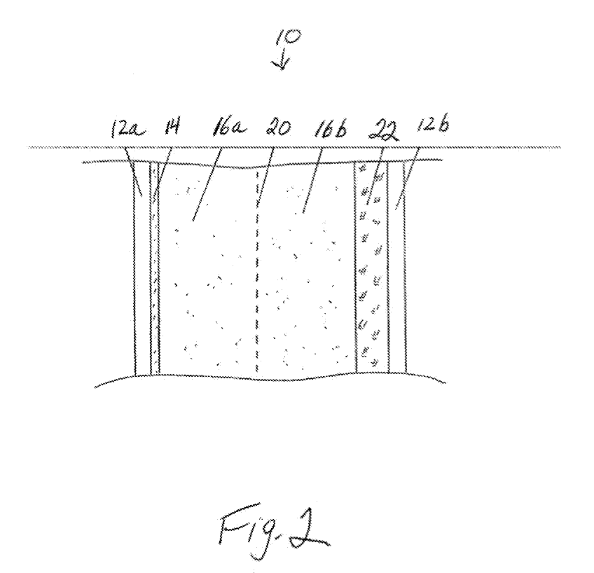

With reference to FIGS. 1 and 2, a simplified component diagram of an exemplary wall panel 10 is illustrated in accordance with one embodiment of the present invention. In the illustrated embodiment, the panel 10 includes five (5) layers 12, 14, 16, 20, 22, respectively.

As best seen in FIG. 2, two (2) of the first layers 12a, 12b are exterior layers of the panel 10. The first layers 12a, 12b act as a coating to the other layers 14, 16, 20, 22. In one embodiment, the first layers 12a, 12b are two-component thermoplastic materials (e.g., Polyurethane and/or Polyurea). These layers 12a, 12b may vary in thickness, ranging from about ⅛″ to about ¼″ and, in the illustrated embodiment, extend across the top and bottom edges 24, 26, respectively, and the left and right edges 30, 32, respectively, to completely coat (e.g., encapsulate) the other layers 14, 16, 20, 22 of the panel 10. The elastomeric properties of the Polyurethane and/or Polyurea coating layers 12a, 12b assist in reflecting or attenuating blast pressure received by the panel 10, as well as assisting in restricting ballistic penetration: In one embodiment, the elastomeric properties of the Polyurethane and/or Polyurea coating layers 12a, 12b contains no volatile organic compounds (VOC's) will meet the ASTM codes cited for tensile strength, elongations, and hardness.

The first layers 12a, 12b act to compress the other layers 14, 16, 20, 22 of the panel 10 together, which adds strength to the panel 10. For example, as discussed in more detail below, the first layers 12a, 12b act to compress the other layers 14, 16, 20, 22 of the panel 10 together to achieve a compression of about 6,000 psi to about 10,000 psi.

Companies such as, but not limited to, ArmorThane, Line-X, and Specialty Products Inc. (SPI) have produced Urethane products/Polyurea products. As stated by the Polyurea Development Association, the advantages and benefits of Polyurea include: no VOC's and little to no odor; some systems are USDA and potable approved; weather tolerant (cures at about −25° F. to greater than about 300° F., even in high humidity); excellent resistance to thermal shock; flexible: bridges cracks; waterproof, seamless and resilient; unlimited mil thickness in one application; spray, hand mix, and caulk grade materials; excellent bond strengths to properly prepared substrates; resistant to various solvents, caustics, and mild acids; and low permeability, excellent sustainability. Furthermore, Line X's PAXCON PX-2100 and PAXCON PX-3350 have passed the H. P. White Certification and been approved by the US Air Force for anti spalling and blast mitigation.

The second layer 14 includes a composite reinforcement (e.g., hardwire). In one embodiment, the second layer 14 of composite reinforcement is between about 0.02″ and about 0.06″ thick and includes high tensile steel wires held in place with, for example, a fiberglass or fabric mesh The second layer 14 acts as an additional component for fortifying the entire face (e.g., from) of the panel 10 to reduce the effectiveness of ballistics penetration (or increase resistance to ballistics penetration).

The third layer 16 includes a concrete mix. In one embodiment, the concrete mix for the third layer 16 includes a calcium sulfoaluminate cement with a non-standard ceramic aggregate. A standard aggregate (as opposed to a non-standard aggregate) is, for example, rocks ranging from a ⅜″ to crushed rock as large at 1¼″. Standard concrete used in floors and walls typically usually uses a 3/4″ minus, meaning ¾″ or smaller. Average concrete slabs of, for example, Portland cement typically have a compressive strength of about 4,000 psi to about 5,000 psi. Because of the type of cement and additives used (which, as discussed below, includes calcium sulfoaluminate), along with the amount of cement, above average compressive strengths in the range between about 6,000 psi and about 10,000 psi will be established. The amount of cement varies and is typically determined by a specified requirement. The greater the amount of cement usually results in a greater psi rating. The average bagged concrete mix, which achieves about 4,000 psi minimum, is a 6:1 ratio (e.g. 1 part cement, 2 parts sand and 4 parts rock (aggregate)). A “rich” mix, meaning high in cement will have a ratio as low as 4:1 ratio (e.g., 1 part cement to 4 parts sand and aggregate). It is contemplated that the concrete mix in the third layer 16 is richer than average to achieve higher strengths (e.g., psi ratings).

The third layer 16 serves to add additional resistance to the ballistics and blast capabilities of the panel 10 while, at the same time, allowing the panel 10 to maintain the above standard compressive strength. Furthermore, when used in conjunction with the other layers 12a, 12b, 14, 20, 22 in the panel 10, the concrete mix third layer 16 is able to attain a higher than normal flexural strength (e.g., between about 2,000 MPa to about 3,000 MPa, as opposed to the typical about 1,000 MPa to about 2,000 MPa), giving the panel 10 added resistance and absorption properties most commonly associated with blast pressures.

In one embodiment, the non-standard aggregate is an alumina ceramic by-product, which adds specific characteristics not normally accredited to average concrete mix designs. The additional characteristics include, but are not limited to, less spalling, less cracking, chemical resistance to alkalis and mineral acids; high density (approximate true density between about 3.50 and about 4.0 with a bulk specific gravity of between about 3.00 and about 3.80 and an apparent porosity of about 3.8% to about 4.2%); extreme hardness with a Knoop hardness of about 2,000; high thermal conductivity (at about 100 degrees C., about 0.065 to about 0.070 cal/sec cm C); good resistance to thermal and mechanical shock; high heat capacity (specific heat at about 20 degrees C. between about 0.19 and about 0.23 cal/gm/C); and excellent abrasion resistance. The non-standard aggregate resists cracking.

In one embodiment, the of the third layer 16 is between about 2 inches and about 5 inches thick and includes:

| | |
|---|---|
| Cement (e.g., calcium sulfoaluminate | about 30% to about 40% |
| cement) | |
| #70 Sand | Zero (0)% to about 22% |
| Ceramic and/or Jagged Rock (e.g., crushed | about 42% to about 50% |
| material having a largest diameter of | |
| about 3 mm to about 8 mm) | |
| Citric Acid | about 0.0125% |
| Superplasticiser | about 0.025% to about 2% |
| Fortifier | about 0.025% to about 2% |
| Fiber | about 0.125% to about 2% |
| Tungsten | Zero (0)% to about 40% |

The percentages listed above will vary slightly for many reasons that include, but are not limited to, ambient temperature, variations in the materials used, water content, radiation shielding requirements etc.

The superplasticiser, fortifier and fiber are all industry wide additives for concrete product. A superplasticiser is used, for example, to reduce water in the concrete, giving the concrete higher strength. The fortifier is used to increase and strengthen bonding between the cement and the aggregates. The fiber, which may include fiberglass, polyfibers, and/or steel, is used to increase the strength of the concrete.

Regarding the ceramic or jagged rock listed above, ceramic alone may provide relatively more ballistic protection and/or thermal mitigation (reduction). The calcium sulfoaluminate provides protection against nuetron radiation. In addition, the optional tungsten provides protection against gamma radiation.

In another embodiment, a panel is contemplated that meets minimal ballistic and blast requirements, while achieving Gamma shielding, for situations that do not require protection against high or extreme threats. A base design formula for this embodiment may include, for example, a different concrete formula. For example, in this alternate embodiment, the third layer includes:

| | |
|---|---|
| Portland Cement (As defined by, but not | about 15% to about 30% |
| limited to ASTM C 150 Types I/II-Type V) | |
| Sand (As defined by, but not limited | about 25% to about 40% |
| to ASTM C33, ⅜″-#50 mesh) | |
| Aggregate (As defined by, but not limited to | about 25% to about 40% |
| ASTM C33, ½″ minus crushed or pebble) | |
| Fiber (Such as, but not limited | about 0.125% to about 4% |
| to nylons, fiberglass, metal, Kevlar) | |
| Tungsten | Zero (0)% to about 20% |

The fourth layer 20 includes a mesh, which acts as a support for the concrete layer 16. In that regard, the mesh layer 20 is embedded in the third layer 16 when the concrete third layer 16 is poured. In one embodiment, the mesh fourth layer 20 is approximately centered in the third layer 16. However, other embodiments, in which the mesh fourth layer 20 is embedded at other positions within the third layer 16 are also contemplated.

It is contemplated that the mesh 20 is an open “over-under” weave design that defines gaps between about ¼″ to about 9/16″. In one example, the mesh 20 includes at least one of copper and 10-12 gauge high carbon steel. If the mesh 20 includes copper, the mesh 20 would act as a Faraday cage to reduce to possibility of eavesdropping. The mesh 20 provides several functions in the panel 10. For example, the mesh 20 adds additional ballistics protection. The mesh 20 is also a key component against blast pressures. The weave design in conjunction with the steel material acts to permit some flex in the mesh 20, while maintaining strength and integrity. Furthermore, it helps to reduce or prevent “blow outs” from the front or back of the panel 10 due to ballistic strikes.

The fifth layer 22 is a ballistic fiberglass that acts as a reinforcement for the panel 10. The fifth layer 22 is considered as a back side of the panel 10. In one embodiment, the fifth layer 22 of ballistic fiberglass varies in thickness (e.g., from about ¼″ to about 1″). Acting as a spall liner, the fifth layer 22 of ballistic fiberglass provides a last line of defense against ballistic penetration. Due to the nature of the aggregate used in the concrete mix, it protects against the aggregate itself from becoming a ballistic projectile.

Gamma radiation is a hazard from multiple sources including; but not limited to, nuclear weapons, mixed nuclear waste, and others. In one embodiment of the present invention, it is proposed to minimize gamma radiation exposure by incorporating a shielding material that absorbs a wide variety of radiation from various gamma emitting sources. Various high atomic weight materials are effective in gamma radiation shielding. Lead, tungsten, depleted uranium, and others are effective gamma shielding materials. Gamma radiation shielding materials including tungsten, tungsten alloys, tungsten carbide, and derivatives of tungsten, and depleted uranium are utilized in embodiment of this invention because of their efficiency of absorption and because of their low toxicity. In one embodiment of the invention, it is contemplated that one of the gamma radiation shielding materials and gamma radiation absorbers is incorporated into the third layer 16 of concrete mix to reduce or minimize gamma radiation penetration in the panel 10, while maintaining the structural wall integrity and blast/ballistic resistance of the panel 10.

It is contemplated that the panel 10 as shown in FIGS. 1 and 2 will be about 8 ft wide (see “W” in FIG. 1)×about 8 ft high (see “H” in FIG. 1) with a thickness (depth) of between about 3″ and about 6″ (see “D” in FIG. 1).

Since the panel 10 includes multiple layers and protects against multiple threats, the panel 10 may be referred to as a multi-layer, multi-threat (MLMT) panel, in which the different layers serve different purposes and have different characteristics. As a whole, the panel 10 offers a single product that will protect against blast, ballistics and various radiation threats and assaults. Furthermore, it is contemplated that the panel 10 is non-structural, allowing it to be manufactured in multiple shapes and sizes to accommodate retrofitting on existing structures (e.g., embassies, federal installations, perimeter structures, refineries, etc). A non-structural panel 10 is not part of the structure of the building and may be used as an after-market product (or addition) to the structure. The panel 10 may be described as a monolithic-like structure.

It is contemplated that a properly formulated panel 10, when secured adequately to a structure or testing apparatus, will to withstand at least:
1) Ballistic strike from a .50 caliber projectile or equivalent at minimal range.
Blast of 50 lbs of Pentolite (Composition B, or equivalent) at a stand off distance of 1.2 meters. This would equate to a blast of 150 lbs Pentolite (Composition B, or equivalent) at a stand of distance of 2.0 meters. This will be an estimated total peak reflected pressure of 7,000 psi-ms or greater, with a total wall peak reflected pressure of over 20,000,000 pounds-ms.
3) Various levels of gamma radiation.

The panel 10, as described above, is designed and engineered to protect human life and infrastructure. Properly retrofitted, the panel 10 will protect facilities such as federal buildings, embassies, airports, oil and gas supplies lines and refining facilities, and military fortifications. The panel 10 also offers flexibility in engineering and design so that panel dimensions and thickness can be adjusted to meet various threats based on consumer demand.

In addition, the panel 10, as described above, is designed for a broad range of multi-purpose uses. For example, the panel 10 provides protection for security based applications ranging from embassies, courthouses and select other locations, to military applications and also for homeland security. Still other uses would include substitution for traditional lead shielding in commodities including x-ray machines, medical radiology suites and others. In yet another use, this material would complement protection used for nuclear blasts. Radiofrequency shielding would be an additional aspect of interest for embassies and military headquarters.

In each of these uses the concept is to provide significant protection for employees from the more likely and even the less likely effects of crime, terrorism or warfare. The potential threats from small arms, car bombs and improvised devices which might include radiation dispersal devices are the most likely security and military based use.

The end result of using this material is that a wide range of protections are available from the same material (e.g., the panel 10).

Ceramic has not been used in concrete mix designs primarily due to it's inherent nature of low porosity. Concrete mixes gain the majority of their strength from the cement's ability to bind to the aggregate. At the molecular level, cement penetrates the pours of the aggregate. During the curing process, the cement in the pours of the aggregate surface bind to the aggregate and the cement surrounding the aggregate. Available ceramics are primarily round (ranging from the size of a BB to the size of a large marble) or flat (usually in a tile type form). These forms are too smooth and do not offer a suitable bonding surface for the cement. The crushed aggregate presently disclosed has a substantially higher porosity, allowing more cement surface bonding (e.g., with calcium sulfoaluminate cement). The addition of fortifiers (concrete glues) increases the cements ability to bond to the crushed ceramic.

Overpressure from explosives, chemical, mechanical and other events are often the part of an event with the greatest hazard. This material will provide protection for people or systems (e.g., an office and/or electronic equipment) to enhance survivability. By coupling several kinds of protection; from blast overpressure, ionizing radiation and radiofrequency radiation, the panel described above fulfills several requirements for security and protection simultaneously and in a new and unique way.

A test of a panel disclosed above was conducted with a Chinese Type 56 SKS weapon and 7.62×39 mm rounds of armor piercing and standard ball ammo (e.g., bullet). The panel was between about 3″ and 3.3″ thick (e.g., the two polyurea layers were about ⅛″ thick each, the composite reinforcement (e.g., hardwire) layer was about 0.04″ thick, the concrete mix layer was about 2.43″ thick, the mesh layer was about 0.01″ thick with an open “over-under” weave design defining gaps of about 0.25″, and the ballistic fiberglass layer was about 0.50″ thick). The formula of the concrete mix layer was within the embodiments described above. The bullet was shot from a distance of 27′, penetrated the panel about 1⅛″, created a shock cavity zone of about 1.390625″ and an entry hole of a diameter of about 3/32″. The bullet was stopped by the mesh layer of the panel and about 1.10″ before the ballistic fiberglass layer. After hitting the panel, the bullet was broken into several pieces (see, for example, the bullet 36).

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A multi-threat panel, comprising:
two layers of polyurea mix for at least one of reflecting and attenuating blast pressure and restricting ballistic penetration of the panel; and
a layer of a concrete mix, including a ceramic aggregate, for increasing resistance to blast pressure and ballistic penetration of the panel, the polyurea layers coating respective sides of the concrete layer.

2. The multi-threat panel as set forth in claim 1, wherein:
the polyurea layers encapsulate the concrete layer.

3. The multi-threat panel as set forth in claim 1, wherein:
the concrete mix is about 30% to about 40% calcium sulfoaluminate cement; and
the ceramic aggregate is about 42% to about 50% of the concrete mix.

4. The multi-threat panel as set forth in claim 1, wherein:
the ceramic aggregate is alumina oxide.

5. The multi-threat panel as set forth in claim 4, wherein:
the concrete mix includes calcium sulfoaluminate cement.

6. The multi-threat panel as set forth in claim 1, further including:
a mesh layer embedded in the concrete layer, the mesh layer including at least one of steel and copper.

7. The multi-threat panel as set forth in claim 6, further including:
a composite reinforcement layer between the concrete layer and one of the polyurea layers; and
a ballistic fiberglass layer reinforcement layer between the concrete layer and the other of the polyurea layers.

8. The multi-threat panel as set forth in claim 7, wherein:
the composite reinforcement layer includes hardwire.

9. The multi-threat panel as set forth in claim 7, wherein:
the polyurea layers encapsulate the concrete layer; and
the concrete layer, the mesh layer, the composite reinforcement layer, and the ballistic fiberglass layer are compressed by the encapsulation of the polyurea layers to achieve a compression of about 6,000 psi to about 10,000 psi.

10. The multi-threat panel as set forth in claim 1, wherein:
the concrete layer of the concrete mix also includes a tungsten material for increasing protection against gamma radiation.

11. The multi-threat panel as set forth in claim 10, wherein:
the two polyurea layers also include a tungsten material for increasing protection against gamma radiation.

12. The multi-threat panel as set forth in claim 1, wherein:
the thickness of the concrete layer is between about 3″ and about 4″.

13. The multi-threat panel as set forth in claim 12, wherein:
the thickness of each of the polyurea layers on the respective sides of the concrete layer is about ¼″.

14. A coated concrete mix, comprising:
a concrete mix that is about 30% to about 40% of a calcium sulfoaluminate cement and about 42% to about 50% of a ceramic aggregate; and
a coating on the concrete mix that includes a polyurea mix.

15. The coated concrete mix as set forth in claim 14, wherein:
the polyurea mix coating is about ¼″ thick.

16. The coated concrete mix as set forth in claim 14, wherein:
the concrete mix is between about 3″ and about 4″ thick.

17. The coated concrete mix as set forth in claim 14, wherein:
the concrete mix is also zero % to about 40% tungsten.

18. The coated concrete mix as set forth in claim 14, wherein:
the ceramic aggregate is alumina oxide.

19. The coated concrete mix as set forth in claim 14, wherein:
the coating of the polyurea mix encapsulate the concrete mix; and
the concrete mix is compressed by the encapsulation of the polyurea mix to achieve a compression of about 6,000 psi to about 10,000 psi.
